(19) United States
(12) Patent Application Publication
(10) Pub. No.: US 2022/0098084 A1
(43) Pub. Date: Mar. 31, 2022

(54) METHODS FOR INCREASING DEPOSITION IN A FLAME HYDROLYSIS DEPOSITION PROCESS

(71) Applicant: CORNING INCORPORATED, CORNING, NY (US)

(72) Inventors: Dale Robert Powers, Painted Post, NY (US); Pushkar Tandon, Painted Post, NY (US)

(21) Appl. No.: 17/323,593

(22) Filed: May 18, 2021

Related U.S. Application Data
(60) Provisional application No. 63/027,597, filed on May 20, 2020.

(51) Int. Cl. C03B 37/018

(52) U.S. Cl. CPC C03B 37/01838

(57) ABSTRACT

A method of forming an optical fiber preform includes flowing a precursor stream through a burner toward a substrate, the precursor stream comprising a glass precursor gas and a carrier gas, the carrier gas having a kinematic viscosity at 2000 K of greater than 5 cm²/sec and a ratio of heat capacity to universal gas constant (Cₚ/R) 2000 K of less than 4; flowing an inflammable gas through the burner; pyrogenically forming glass particles from the glass precursor gas, the pyrogenically forming comprising combusting the inflammable gas; flowing a shield gas through the burner, the shield gas flowing between the precursor stream and the inflammable gas, the shield gas having a kinematic viscosity at 2000 K of greater than 5 cm²/sec and a ratio of heat capacity to universal gas constant (Cₚ/R) at 2000 K of less than 4; and depositing the glass particles onto the substrate.

### CROSS-REFERENCE TO RELATED APPLICATIONS

This application claims the benefit of priority under 35 U.S.C. § 119 of U.S. Provisional Application Ser. No. 63/027,597 filed on May 20, 2020, the content of which is relied upon and incorporated herein by reference in its entirety.

### FIELD

The present disclosure generally relates to forming optical fiber preforms and, more specifically, to methods for increasing deposition rates during formation of optical fiber preforms in a flame hydrolysis deposition process.

### BACKGROUND

An Outside Vapor Deposition (OVD) process may be used in the making of optical fiber preforms. In a typical Outside Vapor Deposition (OVD) process, silica and doped silica particles are pyrogenically generated in a flame and then thermophoretically deposited onto a target to make the optical fiber preform. Accordingly, there is a need to increase the thermophoretic deposition rate of particles to increase production efficiency and lower manufacturing costs.

### SUMMARY

Accordingly, to increase the production efficiency and soot deposition rates and thereby lower manufacturing cost of an optical fiber preform, embodiments of the methods described herein increase the soot thermophoretic deposition rate and consequently the deposition capture efficiency.

In a first embodiment, the present description extends to a method of forming an optical fiber preform, comprising: flowing a precursor stream through a burner toward a substrate, the precursor stream comprising a glass precursor gas and a carrier gas, the carrier gas having a kinematic viscosity at 2000 K of greater than 5 cm2/sec and a ratio of heat capacity to universal gas constant (Cp/R) at 2000 K of less than 4; flowing an inflammable gas through the burner; pyrogenically forming glass particles from the glass precursor gas, the pyrogenically forming comprising combusting the inflammable gas; flowing a shield gas through the burner the shield gas flowing between the precursor stream and the inflammable gas, the shield gas having a kinematic viscosity at 2000 K of greater than 5 cm2/sec and a ratio of heat capacity to universal gas constant (Cp/R) at 2000 K of less than 4; and depositing the glass particles onto the substrate.

According to a second embodiment of the present disclosure, the method of the first embodiment, wherein the carrier gas has a kinematic viscosity at 2000 K of greater than 25 cm²/sec.

According to a third embodiment of the present disclosure, the method of the first embodiment, wherein the shield gas has a kinematic viscosity at 2000 K of greater than 25 cm²/sec.

According to a fourth embodiment of the present disclosure, the method of the first embodiment, wherein the carrier gas has a kinematic viscosity at 2000 K of greater than 28 cm²/sec.

According to a fifth embodiment of the present disclosure, the method of the first embodiment, wherein the shield gas has a kinematic viscosity at 2000 K of greater than 28 cm²/sec.

According to a sixth embodiment of the present disclosure, the method of any one of the previous embodiments, wherein the carrier gas has a heat capacity to universal gas constant (Cₚ/R) at 2000 K of less than 3.

According to a seventh embodiment of the present disclosure, the method of any one of the previous embodiments, wherein the shield gas has a heat capacity to universal gas constant (Cₚ/R) at 2000 K of less than 3.

According to an eighth embodiment of the present disclosure, the method of any one of the previous embodiments, wherein the carrier gas is an inert gas.

According to a ninth embodiment of the present disclosure, the method of the eighth embodiment, wherein the carrier gas is helium or neon.

According to a tenth embodiment of the present disclosure, the method of any one of the previous embodiments, wherein the shield gas is an inert gas.

According to an eleventh embodiment of the present disclosure, the method of the tenth embodiment, wherein the shield gas is helium or neon.

According to a twelfth embodiment of the present disclosure, the method of any one of the previous embodiments, wherein the glass precursor gas is one of silicon tetrachloride (SiCl₄) or octamethylcyclotetrasiloxane (OMCTS).

According to a thirteenth embodiment of the present disclosure, the method of the first embodiment, wherein the precursor stream further comprises a doping precursor, the doping precursor comprising germanium.

According to a fourteenth embodiment, the method of the thirteenth embodiment, wherein the doping precursor is germanium tetrachloride (GeCl₄).

According to a fifteenth embodiment, the method of the first embodiment wherein the carrier gas differs from the shield gas.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims. The accompanying drawings are included to provide a further understanding and are incorporated in and constitute a part of this specification. The drawings illustrate one or more embodiments, and together with the description serve to explain principles and operation of the various embodiments.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. However, the appended drawings illustrate only typical embodiments of the disclosure and are therefore not to be considered limiting of scope, for the disclosure may admit to other equally effective embodiments.

FIG. 1 is a top down view of an exemplary soot depositing burner face showing concentric ring of nozzles in accordance with some embodiments of the present disclosure;

FIG. 2 is a top down view of an exemplary soot depositing burner face showing a concentric ring of nozzles and exemplary gases in accordance with some embodiments of the present disclosure;

FIG. 3 is a flow diagram of a method of forming an optical fiber preform in accordance with some embodiments of the present disclosure; and

FIG. 4 is a schematic view which illustrates an outside vapor deposition process for making a soot core blank in accordance with some embodiments of the present disclosure.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

For purposes of description herein, the terms “upper,” “lower,” “right,” “left,” “rear,” “front,” “vertical,” “horizontal,” and derivates thereof, shall relate to the disclosure as oriented in FIG. 2, unless stated otherwise. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, embodiments depicted in the figures may not be to scale or may incorporate features of more than one embodiment.

In some embodiments, an Outside Vapor Deposition (OVD) process may be used in the making of optical fiber preforms. Outside vapor deposition involves the process of combusting one or more silicon-containing fuels to form silica soot. A burner is configured to burn or oxidize a silicon-containing fuel to produce silica soot particles in a soot stream. The soot stream is expelled toward a substrate such that the silica soot particles are deposited onto the substrate. Additional details regarding an exemplary OVD deposition process are provided by U.S. Patent Publication 2020/0062635, published Feb. 27, 2020 and incorporated by reference herein.

Table 1 is an exemplary recipe for the formation of a typical overclad layer in an OVD process. Table 2 is an exemplary recipe for the formation of a typical core layer in an OVD process.

TABLE 1

| Gas | Flow Rate | |
|---|---|---|
| Octamethylcyclotetrasiloxane (OMCTS) | 24 | g/min |
| Fume O₂ | 7.5 | lpm |
| Inner Shield N₂ | 3.5 | slpm |
| Supplemental O₂ | 17 | slpm |
| Premix CH₄ | 4 | slpm |
| Premix O₂ | 3 | slm |

TABLE 2

| Gas | Max Flow Rate | Min. Flow Rate |
|---|---|---|
| GeCl₄ (gpm) | 2.83 | 0 |
| SiCl₄ (gpm) | 26.41 | 16.46 |
| Fume O₂ (slpm) | 5.1 | 3 |
| CH₄ (slpm) | 22.48 | 10.06 |
| Burner O₂ (slpm) | 19.79 | 8.45 |
| Inner O₂ (slpm) | 5 | 3.8 |

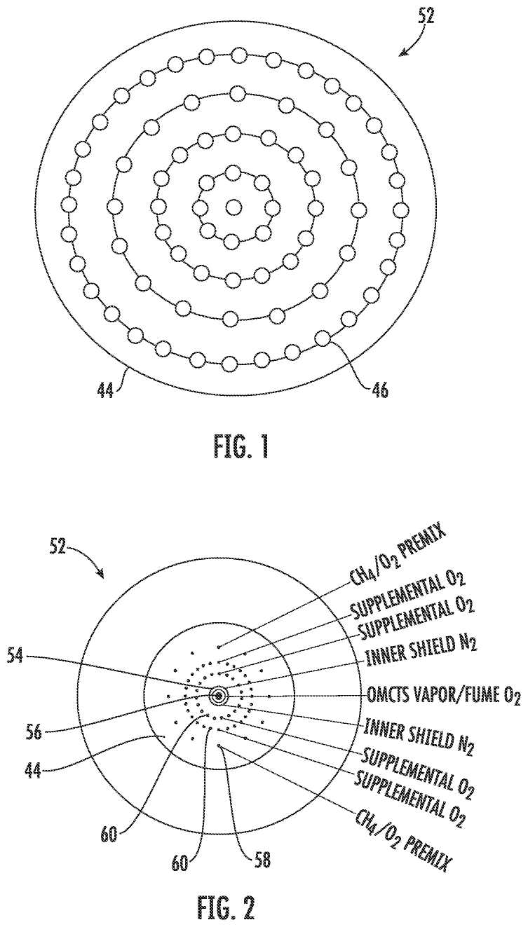

FIG. 1 is an illustration of exemplary burner 52 having a burner face 44. The burner face 44 shows multiple nozzles 46 arranged in concentric rings. Each ring of nozzles 46 in the exemplary burner face 44 of FIG. 1 may pass a different reactant. For example, one set of nozzles 46 may have only a single gas flowing through the nozzles, such as oxygen, at one mass flow rate m1. Other nozzles may have, for example, a mixture of a fuel gas and oxygen flowing through the nozzles at a mass flow rate of m2. Still other nozzles may have one or more glass precursors flowing through the nozzles at mass flow rate m3. The total mass flow rate flowing to the burner flame is the sum of the individual mass flow rates of each nozzle, e.g. mt=m1+m2+m3+ . . . . Each nozzle has a certain cross-sectional area, and the cumulative, or total cross-sectional area of all the nozzles comprises the total nozzle cross sectional area of the burner 52. Although the burner face depicted in FIG. 1 illustrates nozzles grouped in rings, other nozzle designs are within the scope of the invention and FIG. 1 should not be considered limiting in this regard. For example, the burner nozzles may comprise concentric annular nozzles.

FIG. 2 is an illustration of an exemplary burner 52 passing a mixture of gases as listed in Table 1 above for the formation of an overclad layer via an OVD process. The gases include a combined fume O₂ and OMCTS gas stream from a first opening 56 at the center of the burner face 44, a pre-mixed gas stream of CH₄ and O₂ from one or more second openings 58 at a periphery of the burner face 44, a supplement O₂ gas stream from one or more third openings 60 positioned between the first opening 56 and the one or more second openings 58, and a shield gas N₂ stream from one or more fourth openings 54 positioned between the one or more third openings 60 and the first opening 56. As sued herein, the term “premixed” means that two or more constituents (e.g., the fume O₂ and OMCTS) are substantially homogeneously mixed prior to exiting the burner face. The pre-mixed O₂ and CH₄ are ignited and burned proximate the burner face 44. The flames of the burning pre-mixed gases ignite the OMCTS producing a silica soot jet extending away from the burner face and toward a substrate to be deposited thereon. Combustion of the supplemental O₂ forms a secondary flame to aid in combustion of excess fuels and silicon laden compounds.

Thermopheresis is the dominant mechanism of soot capture in an OVD process. To increase the production efficiency and soot deposition rates and thereby lower manufacturing cost of an optical fiber preform, embodiments of the method described herein increase the soot thermophoretic deposition rate and consequently the deposition capture efficiency.

Thermophoretic deposition flux is given by the following relation:

$$J = - ( {α}_{T} {D}_{p} ) {ϕϱ}_{p} \frac{∇ T}{T}$$

Where [symbol] is the thermophoretic flux, (α_{T}Dₚ) is the thermophoretic diffusivity, ϕ is the soot volume fraction, [symbol] ₚ is the particle density, ∇T is the temperature gradient in the thermal boundary layer close to the target or substrate and T is the gas temperature. A fraction of the total flow rate to the burner for the flame in which the soot is generated is from the carrier and shield gases, and gas properties of these gases can be tailored to enhance the thermophoretic deposition rate at the target.

Having a higher kinematic viscosity helps the thermophoretic flux via two different mechanism. The Reynolds number (Re) for the flow to the burner is given as:

$$R e = \frac{D U}{v}$$

where U is the flow speed of the fluid, D is the diameter of the tube, and v is the kinematic viscosity of the fluid.

A higher value of the effective kinematic viscosity of the flame gas mixture results in a lower Reynolds number, making the flame more laminar. A more laminar flame results in a flame with smaller flame volume, thereby increasing the soot stream concentration, increasing the soot volume fraction parameter (parameter ϕ) and hence the thermophoretic flux J.

Secondly, in the flame, the gas mean free path is much larger than the size of the soot particles, resulting in the thermophoresis phenomena to be in the free-molecular regime. In the free-molecular regime, the thermophoretic diffusivity, (α_{T}Dₚ), is insensitive to the soot morphology and size, and given by the following relation:

(α_{T}Dₚ)=0.55 v

Increasing the effective gas kinematic diffusivity results in increased thermophoretic diffusivity (α_{T}Dₚ) and hence higher thermophoretic flux and deposition rate.

A lower value of heat capacity results in a higher value for peak flame temperature for the same amount of combustion of fuel. A higher flame temperature results in increased parameter

$$\frac{∇ T}{T}$$

and thereby a higher deposition rate J.

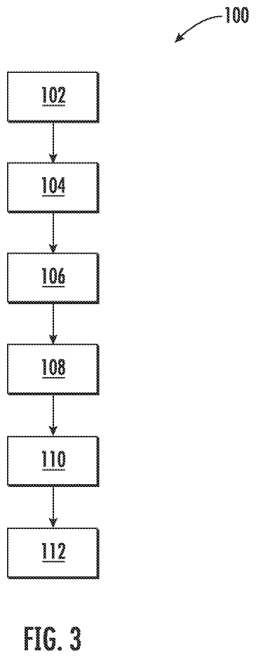

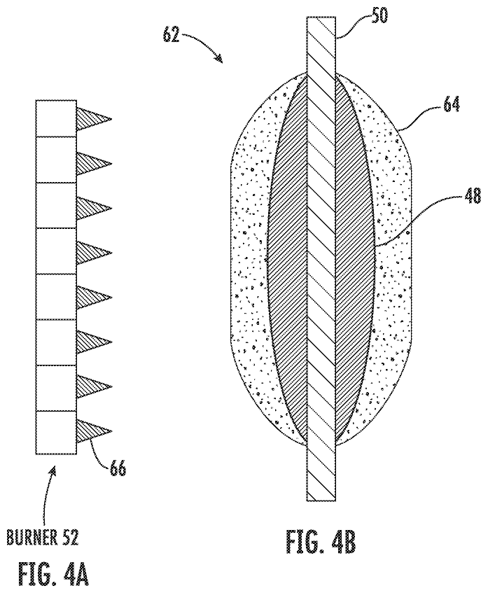

FIG. 3 is a flow diagram of a method 100 of forming an optical fiber preform in accordance with some embodiments of the present disclosure. The method of FIG. 3 is described with reference to FIG. 4 where appropriate.

The method 100 is performed on a starting substrate. In some embodiments, the starting substrate 50 is a bait rod, a soot preform, an optical fiber core cane, other components of an optical fiber preform, components of a glass article, or combinations thereof. At 102, the starting substrate 50 is in a spaced axial alignment with a burner, for example a burner 52 having the alignment depicted in FIG. 1-2.

At 104, a precursor stream comprising a glass precursor gas and a carrier gas are provided to the burner 52. Non-limiting examples of a suitable glass precursor gas include silicon tetrachloride (SiCl₄), octamethylcyclotetrasiloxane (OMCTS), decamethylcyclopentasiloxane, dodecamethylcyclohexasiloxane, hexamethylcyclotrisiloxane, hexamethyldisiloxane, octamethyltrisiloxane, decamethyltetrasiloxane, dodecamethylpentasiloxane, other silicon-containing fuels and/or combinations thereof. In some embodiments, the precursor stream further comprises a doping precursor. In some embodiments, the doping precursor is a germanium-containing compound, such as germanium tetrachloride (GeCl₄).

The glass precursor gas is transported to the face of the burner 52 by the carrier gas. The carrier gas has a kinematic viscosity at 2000 K of greater than 5 cm²/sec. In some embodiments, the carrier gas has a kinematic viscosity at 2000 K of greater than 25 cm²/sec. In some embodiments, the carrier gas has a kinematic viscosity at 2000 K of greater than 28 cm²/sec. In some embodiments, the carrier gas has a kinematic viscosity at 2000 K of 5 cm²/sec to 25 cm²/sec. In some embodiments, the carrier gas has a kinematic viscosity at 2000 K of 5 cm²/sec to 28 cm²/sec. As used herein, the term “kinematic viscosity” is the ratio of the dynamic viscosity of the subject gas to the gas density.

In some embodiments, the carrier gas has a ratio of heat capacity to universal gas constant (Cₚ/R) at 2000 K of less than 4. In some embodiments, the carrier gas has a heat capacity to universal gas constant (Cₚ/R) at 2000 K of less than 3. In some embodiments, the carrier gas is an inert gas. For example, in some embodiments, the carrier gas is helium or neon. Gases with lower heat capacity result in a higher flame temperature for an equivalent amount of combustion of fuel. The higher flame temperature results in a higher thermal gradient and thermophoretic flux.

At 106, an inflammable gas is provided to the burner. In some embodiments, the inflammable gas is methane, ethane, propane or carbon monoxide. At 108, the inflammable gas is burned to form a flame. Glass particles are pyrogenically formed from the glass precursor provided to the burner.

At 110, a shield gas is provided to the burner to separate the interaction of the inflammable gas and the precursor gases close to the burner and prevent deposition of the silica-containing soot particles onto the burner. In some embodiments, the shield gas has a kinematic viscosity at 2000 K of greater than 5 cm²/sec. In some embodiments, the shield gas has a kinematic viscosity at 2000 K of greater than 25 cm²/sec. In some embodiments, the shield gas has a kinematic viscosity at 2000 K of greater than 28 cm²/sec. In some embodiments, the shield gas has a kinematic viscosity at 2000 K of 5 cm²/sec to 25 cm²/sec. In some embodiments, the shield gas has a kinematic viscosity at 2000 K of 5 cm²/sec to 28 cm²/sec. The shield gas has a ratio of heat capacity to universal gas constant (Cₚ/R) at 2000 K of less than 4. In some embodiments, the shield gas has a heat capacity to universal gas constant (Cₚ/R) at 2000 K of less than 3. In some embodiments, the shield gas is an inert gas. For example, in some embodiments, the shield gas is helium or neon.

At 112, the glass particles formed in the flame are thermophoretically deposited onto the starting substrate to form the optical fiber preform. The method 100 utilizes carrier gases and shield gases having the properties described herein that increase the deposition flux J to enhance the thermophoretic deposition rate at the starting substrate.

In accordance with one embodiment of the invention shown in FIG. 4, an OVD process deposits a first layer 48 of glass soot on an optical fiber core cane 50 by a soot depositing burner 52 having a flame 66. After the first layer 48 of glass soot has been deposited on core cane 50 a second layer 64 of glass soot is deposited overtop the first layer 48 of glass soot. After the deposition of the second layer 64 of glass soot overtop the first layer 48, the resultant soot preform 62 may be further processed, such as by drying and consolidating the soot preform in accordance with conventional drying and consolidating techniques as are known in the art. For example, the preform may be heat treated in an atmosphere comprising chlorine to dry soot preform 62, followed by further heating soot preform 62 to consolidate the preform into a solid, clear glass preform. The consolidated optical fiber preform may thereafter be drawn into optical fiber by conventional methods. For example, an optical fiber preform may be drawn, for example, by arranging optical fiber preform in a furnace such that optical fiber preform is heated by one or more heaters. A portion, or gob, of the optical fiber preform softens and drops. A thread of glass which connects the gob to the preform—the optical fiber—is thereafter captured, the gob removed, and the optical fiber pulled by a pulling wheel, or tractor, and wound onto a receiving spool.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and, further, it is to be understood that such concepts are intended to be covered by the following claims, unless these claims, by their language, expressly state otherwise.

What is claimed is:

1. A method of forming an optical fiber preform, comprising:
flowing a precursor stream through a burner toward a substrate, the precursor stream comprising a glass precursor gas and a carrier gas, the carrier gas having a kinematic viscosity at 2000 K of greater than 5 cm²/sec and a ratio of heat capacity to universal gas constant (Cₚ/R) at 2000 K of less than 4;
flowing an inflammable gas through the burner;
pyrogenically forming glass particles from the glass precursor gas, the pyrogenically
forming comprising combusting the inflammable gas;
flowing a shield gas through the burner, the shield gas flowing between the precursor stream and the inflammable gas, the shield gas having a kinematic viscosity at 2000 K of greater than 5 cm²/sec and a ratio of heat capacity to universal gas constant (Cₚ/R) at 2000 K of less than 4; and
depositing the glass particles onto the substrate.

2. The method of claim 1, wherein the carrier gas has a kinematic viscosity at 2000 K of greater than 25 cm²/sec.

3. The method of claim 1, wherein the shield gas has a kinematic viscosity at 2000 K of greater than 25 cm²/sec.

4. The method of claim 1, wherein the carrier gas has a kinematic viscosity at 2000 K of greater than 28 cm²/sec.

5. The method of claim 1, wherein the shield gas has a kinematic viscosity at 2000 K of greater than 28 cm²/sec.

6. The method of claim 1, wherein the carrier gas has a heat capacity to universal gas constant (Cₚ/R) at 2000 K of less than 3.

7. The method of claim 1, wherein the shield gas has a heat capacity to universal gas constant (Cₚ/R) at 2000 K of less than 3.

8. The method of claim 1, wherein the carrier gas is an inert gas.

9. The method of claim 8, wherein the carrier gas is helium or neon.

10. The method of claim 1, wherein the shield gas is an inert gas.

11. The method of claim 10, wherein the shield gas is helium or neon.

12. The method of claim 1, wherein the glass precursor gas is one of silicon tetrachloride (SiCl₄) or octamethylcyclotetrasiloxane (OMCTS).

13. The method of claim 1, wherein the precursor stream further comprises a doping precursor, the doping precursor comprising germanium.

14. The method of claim 13, wherein the doping precursor is germanium tetrachloride (GeCl₄).

15. The method of claim 1, wherein the carrier gas differs from the shield gas.
